(19) United States
(12) Patent Application Publication
(10) Pub. No.: US 2006/0278256 A1
(43) Pub. Date: Dec. 14, 2006

(54) Apparatus for treating a firearm

(76) Inventor: Robert Biddy, Beaumont, TX (US)

Correspondence Address: Scott David Compton, 2386 South Dairy Ashford Rd., PO Box 593, Houston, TX, 77077, US

(21) Appl. No.: 11/150,699

(22) Filed: Jun. 11, 2005

(51) Int. Cl. B08B 7/04; B08B 3/00; B08B 3/04

(52) U.S. Cl. 134/34; 134/10; 134/104.2; 134/201

(57) ABSTRACT

An apparatus for applying fluid to firearms including assembled firearms. The apparatus seals a target region of the firearm inside a chamber wherein the target region of the firearm contacts the fluid. Moreover, the apparatus seals the surface area of the firearm outside of the target region from fluid contact.

### FIELD OF THE APPLICATION

The application relates generally to an apparatus for treating firearms by applying fluids to firearms.

### BACKGROUND

Firearms frequently require the removal of residues to ensure their continued operational reliability. Current techniques used to remove residue from firearms include the disassembly of the firearm, removal of residue from target regions on the firearm using mechanical and/or chemical treatments, followed by reassembly of the firearm. The disassembly of firearms allows for the removal of residues from select target regions on the firearms while avoiding treatment of the non-target regions of the firearms. However, the disassembly/reassembly process can be time consuming and can lead to damaged or misplaced firearm parts. Also, when the above techniques are applied to assembled firearms any non-target regions on the firearms may be unintentionally mechanically and/or chemically contacted. An apparatus is needed that allows fluid to be applied to only target regions on firearms for removing residue without having to disassemble the firearms.

### SUMMARY

An apparatus for applying fluid to a target region of an assembled firearm. The apparatus comprises a chamber having a housing; a first fluid disposed within the housing; and a firearm securing clamp inside the chamber. The clamp comprises a seal disposed between the target region of the firearm and a non-target region of the firearm.

### BRIEF DESCRIPTION OF THE FIGURES

FIG. 1A illustrates a side view of an embodiment of the apparatus.

FIG. 1B illustrates a perspective view of an embodiment of the clamp.

FIG. 2 illustrates a side view of an embodiment of the apparatus including a clamp secured firearm inside the apparatus.

FIG. 3A illustrates a perspective view of a clamp in an opened position.

FIG. 3B illustrates a top view of a clamp in a closed position.

FIG. 3C illustrates a top view of a clamp and liner in a closed position.

FIG. 3D illustrates a side view of a firearm in a secured position within a clamp.

FIG. 4 illustrates a side view of at least a third embodiment of the apparatus.

FIG. 5 illustrates a top view of an embodiment of the brace and platform.

FIG. 6 illustrates a side view of at least a second embodiment of a firearm in a secured position within the clamp.

### BRIEF DESCRIPTION

The present application relates to an apparatus for treating firearms by applying various fluids to firearms. In one embodiment, the present application relates to an apparatus for applying various fluids to the target region of an assembled firearm. More specifically, the present application relates to an apparatus and method of applying various fluids to an assembled firearm while sealing both a target region of a firearm and at least one fluid inside the apparatus to allow for mobility or transport of the apparatus while simultaneously applying the fluid to the firearm sealed inside the apparatus.

In a first embodiment, the apparatus includes at least (1) a chamber having a housing for holding at least a first fluid and (2) a firearm securing clamp. In addition, the apparatus may further include means for creating fluid flow within the chamber and means for introducing and removing fluid from the chamber. The apparatus according to the present application will be described in more detail with reference to the embodiments illustrated in the drawings. The drawings are illustrative only, and are not to be construed as limiting the invention, which is defined in the claims.

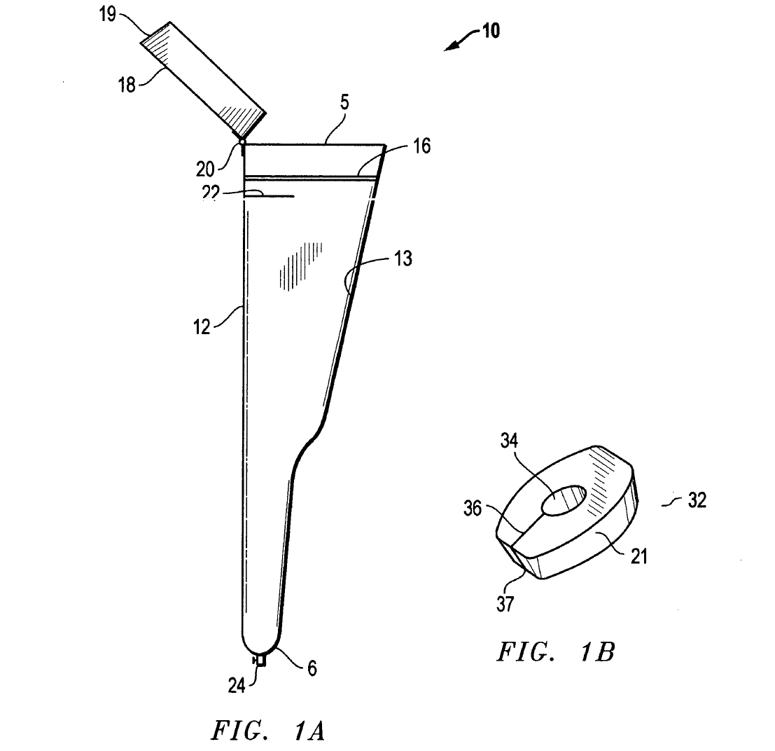

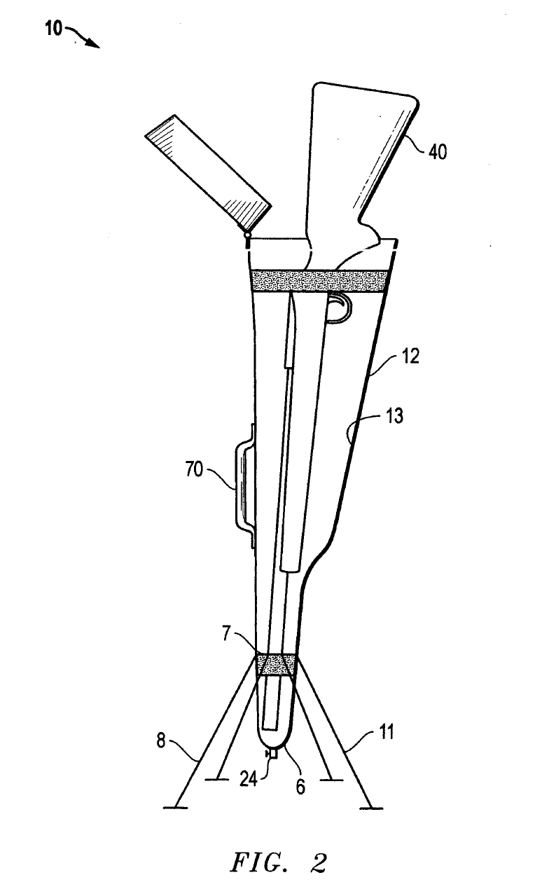

In a first embodiment, as shown in FIG. 1A, the apparatus 10 includes (1) at least a first part chamber 12 having a housing comprising an inner volume, (2) at least a first fluid disposed within the housing, and (3) as shown in FIG. 1B, at least a second part clamp 32 configured to secure and suspend a firearm inside chamber 12. Suitably, clamp 32 is configured to (1) secure and suspend the target region of a firearm inside chamber 12 as clamp 32 rests inside chamber 12, and (2) separate the target region of the firearm apart from the non-target region of the firearm by forming a seal about the firearm. Herein, the target region of the firearm is defined as the region of the firearm that is sealed inside chamber 12 when the firearm is secured by clamp 32 inside chamber 12 as shown in FIG. 2. The non-target region of the firearm is defined as the region of the firearm that is external of and apart from the sealed chamber 12 by clamp 32 and does not contact fluid inside chamber 12. In one embodiment, the non-target region may include the wood stock of firearm 40.

The apparatus 10 may further include a lid 18 positioned to fit securely on the opening or opened rim 5 of chamber 12. Suitably, lid 18 mates with chamber 12, in like manner as clamp 32, to seal the contents of chamber 12 from the outside environment. In addition, the apparatus may include at least one drain 24 configured to allow release of fluids and sediments from chamber 12, and at least one fill line 22 for measuring a suitable amount of fluid to be added to chamber 12. The apparatus 10, as shown in FIG. 2, may further include a handle 70 for lifting and/or carrying the apparatus 10, and a support member 11 configured to support chamber 12 in any orientation effective to retain fluid inside chamber 12 when the chamber is unsealed.

Referring to FIG. 1A, chamber 12 may further include an inner rim 16. Inner rim 16 may run about the periphery of the inner wall of chamber 12 and parallel to opened rim 5 at a predetermined depth within chamber 12. In the alternative, inner rim 16 may comprise individual segments about the periphery of the inner wall of chamber 12. A preferred depth of inner rim 16 is equidistant to the height of lid 18. Thus, inner rim 16 acts as a support or stopper for either lid 18 or clamp 32 as lid 18 or clamp 32 is placed inside chamber 12.

Suitably, chamber 12 is configured to allow at least a portion of firearm 40 to fit within chamber 12. As shown in FIG. 2, inside wall 13 of chamber 12 may be configured to conform to the shape of the firearm to which fluid is being applied, allowing for a minimal amount of space between the inner wall 13 and firearm 40. Minimizing the space between the inner wall 13 and the firearm 40 ensures that the least amount of fluid necessary to contact the target region of the firearm is used. In at least a second embodiment, chamber 12 is configured to house varying types and sizes of firearms and/or multiple firearms.

Herein, firearm refers to any device capable of discharging a projective, usually by detonation of an explosive, including but not necessarily limited to black powder rifles, handguns, rifles, assault weapons, and shotguns, wherein handguns further includes but is not necessarily limited to semi-automatic and fully automatic pistols, revolvers, bolt-action and single shot handguns; wherein rifles further includes but is not necessarily limited to bolt-action rifles, single-shot rifles, semi-automatic rifles, fully-automatic rifles, pump action rifles, lever action rifles, and double barrel rifles; wherein assault weapons further includes but is not necessarily limited to any military weapon that fires multiple rounds upon a single compression of the trigger mechanism of the weapon; and wherein shotguns further includes but is not necessarily limited to automatic shotguns, semi-automatic shotguns, pump action shotguns, over and under shotguns, double barrel shotguns, bolt action shotguns, and single shot shotguns.

Herein fluid refers to any flowable liquid, gas or supercritical fluid effective to contact the target region of a firearm and/or effective to penetrate firearm residue on contact, soften, lift, remove or otherwise affect residue on firearm 40 while secured inside chamber 12. Preferred fluids include but are not necessarily limited to inert gases, supercritical CO₂, water, water-based cleaners, biodegradable cleaners, d-limonene, detergent mixtures, water soluble mixtures including rust inhibitors, mild alkaline based cleaners, mild alkaline based cleaners with rust inhibitors, general purpose cleaners, and solvent based cleaners, including but not necessarily limited to bore cleaners, copper solvents, lead removing solutions, nitro solvent, rust removers, mineral spirits and combinations thereof. Representative fluids may be obtained from the following commercial sources: West Penetone, Ecolink, Florida Chemical Company, Inc., and Worldwide Chemicals Inc.

In one non-limiting example of the present disclosure, the length of inner rim 16 extends outward from inner wall 13 at about ¼ inch to about ½ inch, preferably ½ inch. Lid 18 and clamp 32 are adapted to rest inside chamber 12 in a corklike manner. Suitably, lid 18 and clamp 32 are configured to rest inside chamber 12 to form a seal between inner wall 13 and outer wall 19 or outer wall 21 to inhibit fluid flow from chamber 12. A seal can be created with or without the addition of inner rim 16.

In an embodiment comprising inner rim 16, a seal is created as either lid 18 or clamp 32 is placed within chamber 12 to a point where the bottom side of lid 18 or clamp 32 contacts the topside of inner rim 16. Contact of lid 18 or clamp 32 against inner rim 16 seals chamber 12 by creating a flush alignment at a point where the bottom and side of lid 18 or clamp 32 meets the corner of inner wall 13 and topside of inner rim 16. Suitably, lid 18 and clamp 32 comprise an outer shape that corresponds to the shape of inner wall 13. In at least a first embodiment, outer wall 19 or 21 further comprises a tapered configuration that corresponds to the tapered configuration of inner wall 13 to further assist in sealing chamber 12.

As shown in FIG. 1A, lid 18 may be either fixed to chamber 12 by hinge 20, or in the alternative, attached to chamber 12 by any other suitable means whereby lid 18 can be swung into chamber 12 or removed from chamber 12 about hinge 20. In addition, hinge 20 may be removable allowing lid 18 to be disconnected or separated from apparatus 10. In at least one embodiment, hinge 20 is adjacent to the opened rim 5, wherein lid 18 is swung into and out of chamber 18 in a manner effective to seal chamber 12.

Clamp 32 may be fixed to chamber 12 in like manner as lid 18, or in the alternative, clamp 32 may be a separate piece from chamber 12. Suitably, clamp 32 comprises a solid piece of material defined by an opening 34 there through and slit ends 37 running radially from a point adjacent to opening 34 to the outer wall 21. Clamp 32 is configured to secure firearm 40 within opening 34 while also being configured to form a seal about firearm 40. As shown in FIG. 1B, slit ends 37 define a slit 36 that allows clamp 32 to open from a closed position by separating the slit ends 37. Clamp 32 is further adapted to create a seal about firearm 40 when slit ends 37 come to a mated position around the firearm 40, thus securing firearm 40 within. In at least a second embodiment, clamp 32 is configured to secure multiple firearms within opening 34.

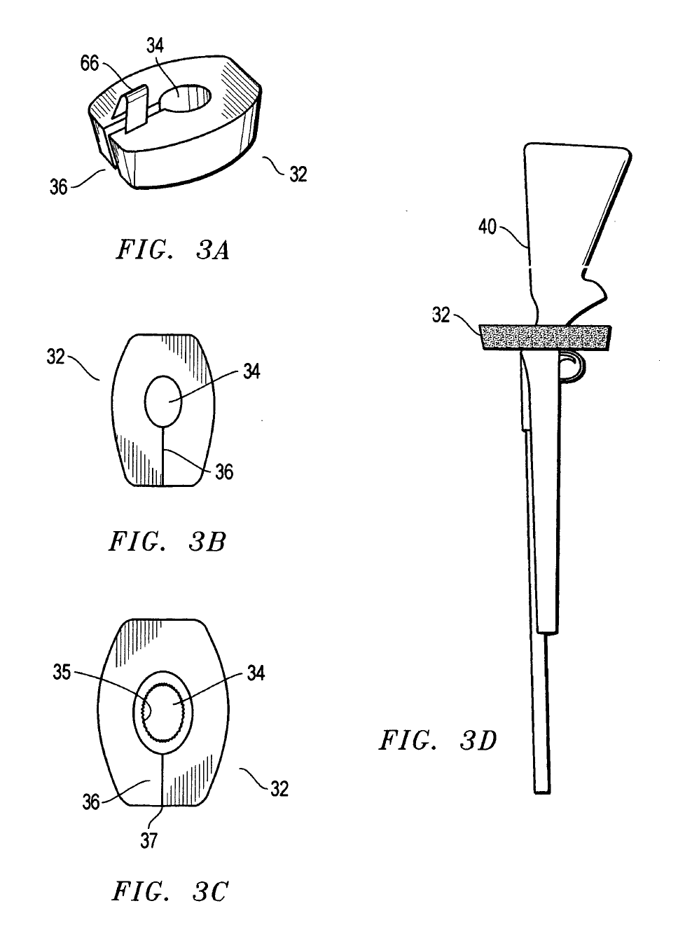

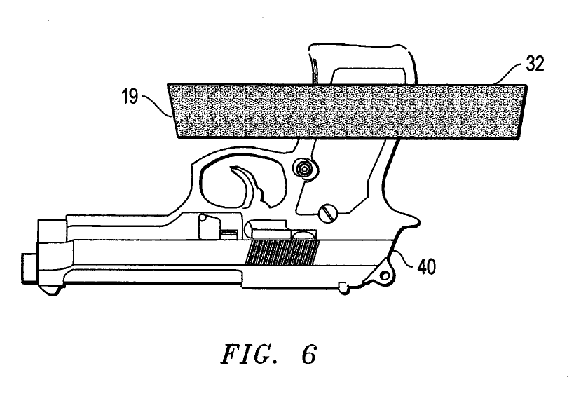

A suitable opened position of clamp 32 comprises slit ends 37 being separated from a mated position at a distance greater than the width of a neutral point on firearm 40, thus allowing firearm 40 to be secured within opening 34. The neutral point is herein defined as the region of firearm 40 adjacent but not including the target area of firearm 40 that is enveloped by clamp 32. Examples of clamp 32 securing firearm 40 are shown in FIG. 3D and FIG. 6.

Slit ends 37 may comprise any pathway from opening 34 to outer wall 21 effective to allow firearm 40 to be secured within opening 34. In an alternative embodiment, clamp 32 may comprise a continuous or slitless construction wherein clamp 32 is adapted to be stretched open to allow firearm 40 to be run through either side of opening 34 and to be secured therein.

Suitably, clamp 32 comprises an outer wall 21 configuration adapted to sealably mate with the inner wall 13 of chamber 12. In addition, clamp 32 is made of any material effective to secure and suspend firearm 40 while also sealing chamber 12 as described above. A preferred material includes but is not necessarily limited to plastic, rubber, polyurethane, metal, polyvinyl chloride (PVC), polytetrafluoroethene (PTFE) and other synthetic materials or combinations thereof. Preferred rubbers include but are not necessarily limited to EPDM rubber and silicone rubber. The inner wall of opening 34 may comprise a machine fit design for a particular model firearm, or in the alternative, the inner wall of opening 34 may comprise a corrugated region or other non-uniform surface effective to increase the seal between clamp 32 and firearm 40.

As shown in FIG. 3A, clamp 32 may further comprise at least one strap 66 positioned on the topside of clamp 32 to assist the removal of clamp 32 from chamber 12. The strap 66 is configured to allow a user to grasp and pull strap 66 by hand to assist in removing clamp 32 from chamber 12. Strap 66 can be positioned at any location on the topside of clamp 32. In addition, strap 66 can be permanently joined to clamp 32 at one end of the strap 66 or at multiple ends of strap 66. In one embodiment strap 66 is permanently joined at one end to clamp 32, while the opposing end of strap 66 is removably detachable to clamp 32 using a metal snap or other detachable fastening device.

As shown in FIG. 3C, clamp 32 may also comprise a liner 35 on the wall of opening 34 that furthers seals firearm 40 by conforming to the neutral point of firearm 40, thus filling surface irregularities on the firearm 40. Suitably, liner 35 is comprised of any material adapted to change form, particularly any material adapted to form about various firearms creating seal between the liner 35 and the neutral point of firearm 40. In addition, the diameter or length of opening 34 is dependant on the type of firearm 40 to be treated.

Preferred liner materials include but are not necessarily limited to plastic, rubber, and polyurethane foam. Liner 35 may be securely attached to clamp 32 forming a single piece of construction, or liner 35 may be comprised of a separate piece that is placed between inner wall of clamp 32 and firearm 40 prior to treatment of the firearm. Herein, treatment refers to the application of fluid to the target region or regions of firearms.

Fill line 22 is effective to indicate a suitable volume of fluid to be added to chamber 12 prior to treatment of the firearm 40. Herein, the treatment of firearm 40 refers to the direct contact of a fluid upon firearm 40 within chamber 12. Fill line 22 may be etched into the wall of chamber 12, or in the alternative fill line 22 may be applied to chamber 12 by any suitable means including but not necessarily limited to paint, a silk screening technique or any other ink based application. In operation, a preferred fluid is added to chamber 12 until the fluid reaches fill line 22. Preferably, fill line 22 is positioned on chamber 12 at a point to avoid overfilling of the fluid as the target region of firearm 40 is placed inside chamber 12.

At least one embodiment of apparatus 10 includes at least one drain 24 positioned on chamber 12 effective to allow release of fluid and sediments from chamber 12. As shown in FIG. 1, drain 24 is positioned at the bottom or near closed end 6 of chamber 12. Suitable drains for releasing fluid and sediments include but are not necessarily limited to a plastic, copper or other metal-type valves effective to release fluid when in an open position, and effective to maintain a seal when in a shut or closed position. The chamber/drain combination may comprise a one-piece construction, or in the alternative, drain 24 may be inserted into an opening in sidewall of chamber 12. A preferred opening includes but is not necessarily limited to a threaded opening wherein drain 24 is screwed directly into the chamber sidewall, or in the alternative, the drain 24 is placed into a nipple that is fitted into the opening of the sidewall. When a drain is absent, fluid may be removed from the chamber 12 by pouring the fluid out of the opened rim 5.

Chamber 12 may be constructed of any material durable enough to withstand various treatment conditions including but not necessarily limited to chemical environments of varying pH and corrosivity, varying temperatures, varying pressures, and other loads placed upon chamber 12. Suitable materials include but are not necessarily limited to plastics, steel, stainless steel, aluminum, ceramic materials, rubber, PVC, PTFE, plexiglass and combinations thereof. Optionally, chamber 12 can be comprised of a transparent material. A transparent chamber 12 allows for visual observation of the fluid within chamber 12 during operation. Depending on the material used, a preferred wall thickness of chamber 12 is thin enough to maintain transparency while also maintaining the above described durability properties.

In one embodiment, as shown in FIG. 2, at least one handle 70 is positioned on the outer wall of chamber 12. Handle 70 allows a user to lift, carry or otherwise transport apparatus 10 while fluid is being applied to a firearm 40 inside chamber 12. Handle 70 may be comprised of a separate piece that attaches to apparatus 10 or apparatus 10 may comprise a handle 70 continuous with the outer wall of the apparatus 10. In addition, handle 70 may include any gripping means including but not necessarily limited to straps, and handle bars. The apparatus 10 may further comprise a shoulder holster or other strap for transport purposes.

A suitable support member 11 comprises at least a ring 7 for securing closed end 6 of chamber 12. Support member 11 may further comprise a plurality of legs 8 fastened to ring 7 and extending from ring 7 to the ground, floor or other base to further support ring 7. In addition, the apparatus 10 of the present application may comprise any other base suitable to support chamber 12 in a non-horizontal position.

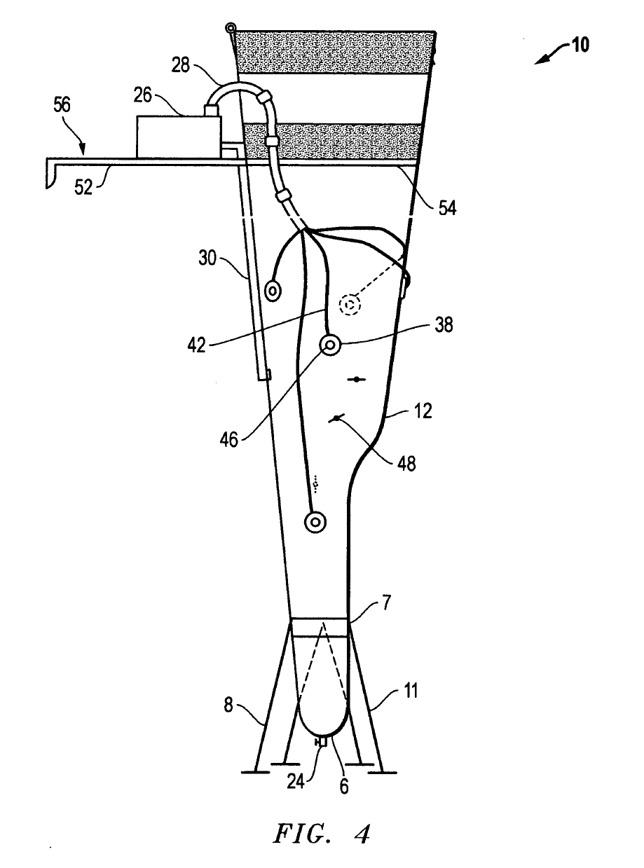

In an alternative embodiment, as shown in FIG. 4, apparatus 10 may be secured in a desired orientation by brace 52. In one embodiment, brace 52 is mounted to a wall or other fixed object effective to secure apparatus 10 in an upright position by a mounting means including but not necessarily limited to a mounting bracket including u-bolts for mounting to a wall or other vertical base. In at least a second embodiment, apparatus 10 may be secured in a desired orientation by brace 52 wherein brace 52 is configured to attach to a passenger vehicle. For example, brace 52 may attach to a rolled down door window of a passenger vehicle or the bed of a pickup truck.

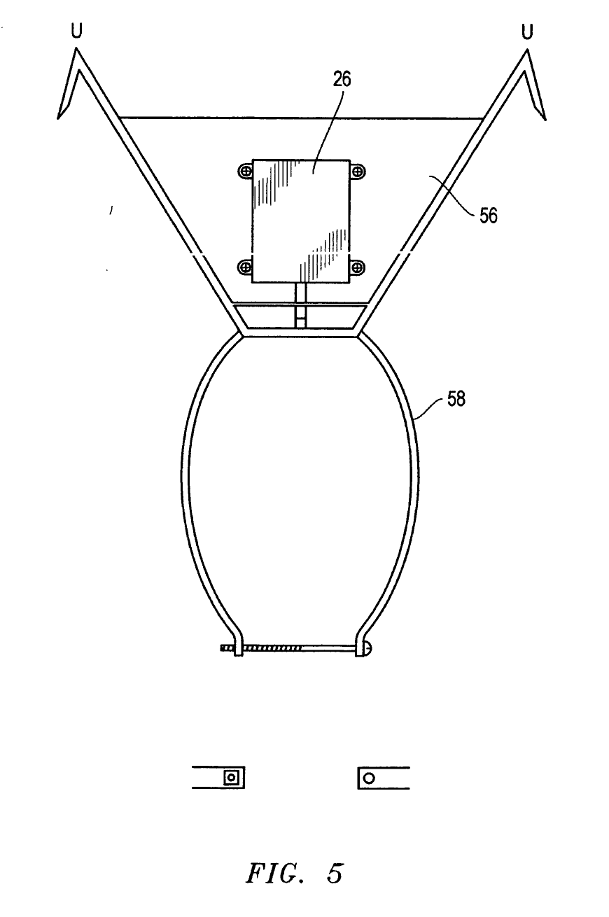

Preferably, the outside wall of chamber 12 comprises a channel 54 corresponding to brace 52 and adapted to allow brace 52 to mate lengthwise with channel 54. Preferably, channel 54 ranges from about ⅛ inches to about ¼ inches deep and from about 1 inch to about 2 inches wide, depending on the brace 52 to be used. Suitably, channel 54 runs about the periphery of the outer wall of chamber 12 and parallel to opened rim 5. Brace 52 may include a loop that fits over and wraps around chamber 12 engaging the corresponding channel 54 along the length of channel 54. Or, in the alternative, brace 52 may comprise at least two arms 58 as shown in FIG. 5. Arms 58 preferably engage channel 54 in like manner as brace 52 a suitable distance about chamber 12 wherein the ends of arms 58 may be further fastened and thereby securely tightening chamber 12 to brace 52. A preferred brace is made of any material durable enough to secure chamber 12 in an upright position. Suitable materials include but are not necessarily limited to plastic, rubber, steel, stainless steel, or other metals. In addition, arms 58 may also be comprised of materials for engaging or wrapping around chamber 12 in channel 54 including but not necessarily limited to plastic, rubber, steel, stainless steel, or other metals, rope, and leather.

As shown in FIG. 4, apparatus 10 may further include at least one pump 26, at least one flow line 28, and at least one return line 30 for circulating fluid into and out of chamber 12. Pump 26 is suitably positioned outside of apparatus 10 and in fluid communication with chamber 12 via flow line 28 and return line 30. Herein, brace 52 may further be used to support pump 26 by forming a platform 56 as shown in FIG. 5.

A preferred pump 26 allows for circulation of fluid within chamber 12 wherein fluid is pumped into chamber 12 via flow line 28 and fluid is removed from chamber 12 via return line 30. Preferably, pump 26 creates a fluid flow violent enough to produce a desired force of fluid upon at least one target region of the firearm 40 being treated within chamber 12. Suitable pumps include but are not necessarily limited to electrical high pressure pumps and low pressure pumps, wherein the high pressure and low pressure pumps further include but are not necessarily limited to dispensing pumps, centrifugal pumps, submersible pumps, piston pumps, screw pumps and vacuum pumps. Preferred pumps may be obtained from the following commercial sources: Fybroc Divison, Met-Pro Corp., Telford, Pa.; March Mfg. Inc., Glenview, Ill.; Complete Dewatering Pumps & Wellpoints, Inc., Edgewater, Fla.; OEC Fluid Handling, Inc., Spartanburg, S.C.; and SCC Pumps, Inc., Arlington Heights, Ill. Suitable pumps may operate using a wall outlet, or in the alternative, a vehicle cigarette lighter may be used to run the pump.

Suitably, the fluid flow provides sufficient pertubation to remove residue located on the target regions of firearm 40. Typical target regions include but are not necessarily limited to the working mechanisms of the firearm 40 including but not necessarily limited to the barrel and the action, wherein the elements making up the action may vary depending on the type of firearm 40 being treated. Typical elements making up the action include but are not necessarily limited to recoil springs, recoil spring guides, slides, shell extractors, trigger mechanisms, bolts, guides, magazines, sights, stocks, forestocks, slides inside the action, slides outside of action, and safeties.

Flow line 28 may further comprise at least one hose 42 and at least one flow jet 38 in fluid communication with flow line 28 and attaching to chamber 12 at variable points on the wall of chamber 12. As shown in FIG. 4, multiple flow jets 38 may be incorporated and connected to various threaded holes 46 effective to direct a concentrated fluid flow in a predetermined pattern within chamber 12, or concentrated fluid flow upon one or more points on the target region of firearm 40.

In at least one embodiment, the wall of chamber 12 includes a plurality of threaded holes 46 for connecting at least one flow jet 38 to allow a concentrated flow of fluid upon a target region of firearm 40 within chamber 12. Suitably, threaded holes 46 comprise a diameter effective to direct a preferred flow of fluid into chamber 12. A preferred threaded hole 46 diameter is from about ½ inch to about ¾ inches, more preferably from about ⅜ inches to about ½ inches, most preferably about ½ inches. Preferably, flow jet 38 is adapted to mate with threaded hole 46 while also (1) allowing a desired fluid flow into chamber 12, and (2) effectively sealing the threaded hole 46 from fluid loss. A preferred flow jet 38 includes but is not necessarily limited to a nipple or other adapter effective to connect threaded hole 46 to hose 42 wherein flow line 28 is in fluid communication with chamber 12. Each unused threaded hole 46 during operation comprises a threaded cap 48 effective to seal chamber 12 from fluid loss through the corresponding threaded hole 46. Threaded caps 48 are adapted to mate with threaded holes 46 in a similar fashion as flow jet 38. Preferred threaded caps 48 comprise a threaded screw including slots on top that allow for easy twisting on or off of the threaded cap 48. Preferably, threaded caps 48 are comprised of any material effective to maintain a seal including but not necessarily limited to plastics, PTFE, rubbers, steel, stainless steel and other metals.

In operation, it is desirable that the present apparatus be (1) sealable and easily transportable or otherwise mobile, (2) effective to apply fluid to a target region of an assembled firearm inside chamber 12 (3) without applying fluid to the non-target region of the firearm, and (4) without leaking, spilling or other fluid loss from chamber 12 during treatment of the target region whether apparatus 10 is stationary or in transport. In at least one embodiment, fluid is applied to a target region of an assembled firearm to remove residue from the target region. In at least a second embodiment, fluid is applied to a target region of an assembled firearm for bluing or chroming of the target region. Herein, an assembled firearm refers to a firearm that includes all working parts, or in the alternative, an assembled firearm refers a firearm including all working parts less the forestock and/or bolt depending on the make of the firearm.

In operation, chamber 12 is filled with a preferred fluid to fill line 22. The fluid may be delivered to chamber 12 by any suitable means including but not necessarily limited to manually pouring the fluid into chamber 12, and pumping the fluid into chamber 12. A preferred fluid for use herein includes any fluid that comprises preferred treatment properties for a particular firearm 40. Preferred treatment properties of a fluid are herein defined as nondestructive properties upon direct contact of the fluid with firearm 40, while simultaneously being effective to treat residue located on firearm 40, as described above.

Depending on the make and model of the firearm, various residues can build up on the firearm over time or after use or firing, including residue buildup on the working mechanisms of the firearm. A suitable fluid used herein removes common residues that build up on firearms after firing. Common residues include but are not necessarily limited to carbonaceous deposits, polymers, resins, greases, heavy tars, oils, products of combustion black powder, copper, dirt, crud, light rust, loose lead, plastic and lead fouling. These residues may accumulate over time and cause malfunctions of the firearm if not removed from the firearm periodically.

In the case of liquid treatment, chamber 12 may be filled with a liquid either prior to placement of the clamp secured firearm into chamber 12, or after the clamp secured firearm has been sealably placed inside chamber 12. When liquid is added to chamber 12 prior to sealing the clamp secured firearm inside chamber 12, a desired amount of fluid is added up to fill line 22. In an embodiment where fluid is added to chamber 12 via a feed line, the clamp 32 and firearm 40 may be placed into the treatment position prior to adding fluid to chamber 12.

Preferably, fill line 22 is at a point on chamber 12 to account for the displacement of fluid created by the treatment region of firearm 40 being added to chamber 12. In addition, the apparatus 10 may comprise multiple flow lines 22, each flow line 22 effective for fluid measurement corresponding to the treatment of varying types of firearms.

In at least one embodiment, the firearm 40 is secured within clamp 32 at a neutral point along the length of firearm 40. Once secured within clamp 32, the clamp 32 and firearm 40 are placed inside chamber 12 at a depth where clamp 32 creates a seal with inner wall 13 of chamber 12, as described above. As shown in FIG. 2, the treatment region of firearm 40 is suspended in the fluid for a preferred amount of time. Herein, a preferred amount of time is defined as the time necessary to remove and/or loosen residue from the target region of firearm 40. A preferred amount of time may vary depending on the fluids and type of residue to be removed from firearm 40.

In one embodiment, the sealed apparatus 10 is positioned vertically or upright during treatment of firearm 40. In an alternative embodiment, sealed apparatus 10 is positioned in any non-upright orientation including placing apparatus 10 in an inverted position wherein closed end 6 is the further most point on apparatus 10 from the ground, floor or other base. An advantage of the sealed apparatus 10 in one embodiment is that the sealed apparatus 10 can be laid on its side as fluid is applied to a target region of firearm 40. For instance, sealed apparatus 10 can be laid on its side in the bed of a pickup truck or the back seat of a vehicle during treatment of firearm 40 as the truck or vehicle is being driven.

Once firearm 40 is treated, clamp 32 and firearm 40 are removed from chamber 12 and allowed to dry. Or in the alternative, further mechanical and/or chemical cleaning of the firearm may be performed.

Treatments using the present apparatus may be performed both indoors and outdoors. When liquids are used, treatments are performed at temperatures ranging from about just above the freezing point to about just below the boiling point of the particular liquid or combination of liquids. Preferably, liquid treatments are performed at temperatures corresponding to the ambient environment of apparatus 10.

In another embodiment as shown in FIG. 4, the clamp 32 and firearm 40 are placed into chamber 12 as described above. In addition, a predetermined number of threaded caps 48 are removed and replaced with flow jets 38 to direct fluid flow upon any number of target regions of firearm 40.

The invention will be better understood with reference to the following non-limiting examples, which are illustrative only and not intended to limit the present invention to a particular embodiment.

### EXAMPLE 1

In one non-limiting example of the apparatus disclosed herein, the apparatus is used to apply a liquid to an assembled pump action shotgun.

The shotgun has the following dimensions:

Length=49.5 inches

Barrel+choke length=32.5 inches

Barrel Width=1⅜ inches

Barrel thickness=1 inch

With of shotgun from bottom of the trigger guard to the top of the action=4 inches

The apparatus has the following dimensions:

Total height=49 inches

Broad side inner dimensions:

Width of apparatus at opened rim=10½ inches

Width of apparatus at point 30 inches from the opened rim=5 inches

Width of apparatus at point 33 inches from the opened rim=3 inches

Width of apparatus at closed end=2½ inches

Narrow side inner dimensions:

Width of apparatus at opened rim=4 inches

Width of apparatus at point 30 inches from the opened rim=4 inches

Width of apparatus at point 33 inches from the opened rim=3 inches

Width of apparatus at closed end=2½ inches

The clamp is comprised of rubber and is 2 inches in height and 8 inches in length. The deepest part of the clamp rests inside the chamber 8 inches from the opened rim. The chamber wall is made of plastic and is ⅜ inches thick.

In operation, the chamber is filled with d-limonene to the fill line. The clamp is opened to allow the barrel and working mechanisms of the shotgun to rest securely inside the clamp opening. Once secure, the clamp and shotgun are placed inside the chamber, sealing the fluid within the chamber and securely suspending the barrel and working mechanisms of the shotgun inside the chamber within the d-limonene fluid. As the shotgun is placed into the d-limonene, the d-limonene rises up to a point where the d-limonene contacts the bottom side of the clamp. The stock of the shotgun is suspended out from both the clamp and the apparatus. The barrel and working mechanisms remain inside the sealed chamber for approximately one hour. After the one hour has elapsed, the shotgun and clamp are removed from the chamber and allowed to dry.

### EXAMPLE 2

The apparatus, shotgun, clamp and fluid as described in Example 1 further comprising a piston pump, a flow line, a return line, and flow jets. The shotgun is placed into the d-limonene causing the d-limonene to rise up within the chamber above the point of attachment of the return line to the chamber.

A 110/220 volt, ¾ hp piston pump is turned on allowing the d-limonene within the chamber to circulate through the return line, into the pump, through the flow line and back into the chamber via flow jets placed at strategic points on the chamber wall. The flow jets are oriented to allow flow of the d-limonene onto the working mechanisms of the shotgun. The flow jets create turbulence in the chamber area to assist in removing residue from the shotgun. The barrel and working mechanisms remain inside the sealed chamber for approximately one hour while the pump is running. After the one hour has elapsed, the pump is turned off and the shotgun and clamp are removed from the chamber and allowed to dry.

The apparatus may also be used to apply fluids to items other than firearms. For example, a clamp may be configured to secure items including but not necessarily limited to one or more golf clubs, various hand held tools and other items including at least one target region to which to apply fluids.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

I claim:

1. An apparatus for applying fluid to a target region of an assembled firearm comprising:
a chamber having a housing wherein at least a first fluid is disposed within the housing; and
a firearm securing clamp inside the chamber;
said clamp comprising a seal disposed between the target region of the firearm and a non-target region of the firearm.

2. The apparatus of claim 1 further comprising at least a first pump in fluid communication with the chamber.

3. The apparatus of claim 1 wherein the inside wall of the chamber may be configured to conform to the shape of the firearm.

4. The apparatus of claim 2 wherein the inside wall of the chamber may be configured to conform to the shape of the firearm.

5. The apparatus of claim 2 further comprising at least one flow jet.

6. The apparatus of claim 4 further comprising at least one flow jet.

7. The apparatus of claim 1 wherein said chamber is comprised of a transparent material.

8. The apparatus of claim 2 wherein said chamber is comprised of a transparent material.

9. The apparatus of claim 1 further comprising a drain.

10. The apparatus of claim 2 further comprising a drain.

11. The apparatus of claim 1 further comprising a brace.

12. The apparatus of claim 2 further comprising a brace.

13. The apparatus of claim 1 wherein the apparatus can be laid on its side as fluid is applied to a target region of the firearm.

14. An apparatus for applying fluid to a target region of an assembled firearm comprising:
a chamber having a housing wherein said chamber is comprised of a transparent material;
a first fluid disposed within the housing;
a firearm securing clamp inside the chamber; and
a pump in fluid communication with the chamber;
said clamp comprising a seal disposed between the target region of the firearm and a non-target region of the firearm.

15. The apparatus of claim 14 wherein the inside wall of the chamber may be configured to conform to the shape of the firearm.

16. The apparatus of claim 14 further comprising at least one flow jet to direct the circulating fluid in a predetermined pattern within the chamber.

17. The apparatus of claim 15 further comprising at least one flow jet to direct the circulating fluid upon one or more points on the target region of the firearm within chamber.

18. The apparatus of claim 14 further comprising a drain.

19. A method of applying fluid to a target region of an assembled firearm comprising:
providing an apparatus including a chamber having a housing for holding at least a first fluid and a firearm securing clamp;
adding at least a first fluid to the chamber; and
placing the clamp securing the firearm inside the chamber wherein the target region of the firearm is contacted by the fluid inside the chamber and the clamp comprises a seal disposed between the target region of the firearm and a non-target region of the firearm.

20. The method of claim 19 wherein fluid is further applied to the target region of the assembled firearm by circulating fluid into and out of the chamber.
